(19) United States
(12) Patent Application Publication
(10) Pub. No.: US 2002/0066112 A1
(43) Pub. Date: May 30, 2002

(54) Computer/television compatibility system

(76) Inventor: Henry Yearwood, Jamaica, NY (US)

Correspondence Address: Henry Yearwood, 116-69 155th Street, Jamaica, NY, 11434, US

(21) Appl. No.: 09/725,699

(22) Filed: Nov. 29, 2000

(51) Int. Cl. H04N 7/173; H04N 7/16; H04N 7/00; H04N 11/00

(52) U.S. Cl. 725/141; 725/133; 348/552

(57) ABSTRACT

A computer-television compatibility device, intended as an accessory to previously existing systems or addition to new systems. More particularly, the present invention is a device or electronic receiver that functions to combine the convenience of features associated with the personal computer, such as pointing, clicking, minimizing, and dragging, with the digital transmissions of a television, via cable line or satellite. A live cable line, antenna, or satellite network signal is sent to an input box, and processed for clarity purposes. The signal is then transmitted to the output section of the device, which is connected to a computer system. A software application functions to display the incoming signal on the previously-existing computer monitor. Such digital television images may then be dragged to a corner of the computer screen, minimized, or maximized by the user. Thus, the computer monitor may function as a partial or full television screen, for entertainment or informational purposes. Such television images may then be recorded by the user via CD or DVD means for subsequent viewing.

### BACKGROUND OF THE INVENTION

1. Field of the Invention

The present invention is a computer-television compatibility device, intended as an accessory to previously existing systems or, alternatively, as a device built into new systems. More particularly, the present invention is a device or electronic receiver that functions to combine the convenience of features associated with the personal computer, such as pointing, clicking, minimizing, and dragging, with the digital transmissions of a television, via cable line, traditional antenna, or satellite signal.

A live cable line, antenna, or satellite network signal is sent to an input box, and processed for clarity purposes. The signal is then transmitted to the output section of the device, which is connected to a computer system. A software application functions to display the incoming signal on the previously-existing computer monitor. Such digital television images may then be dragged to a corner of the computer screen, minimized, or maximized by the user. Thus, the computer monitor may function as a partial or full television screen, for entertainment or informational purposes. Such television images may then be recorded by the user via CD or DVD means for subsequent viewing.

2. Description of the Prior Art

Numerous innovations for compatibility systems and devices have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

1. U.S. Pat. No. 6,119,172, invented by Belmont et al. entitled “Access Control For a TV/PC Convergence Device”

The patent to Belmont et al. describes a TV/PC convergence device, operable in a television mode, a computer mode and a combination television/computer mode, includes a display, a computer and an interface coupled between the display and the computer. The display receives and displays images in all three modes. The computer executes programs and is operable in the computer mode and the combination television/computer mode. The interface includes a access control device for selectively controlling the switching between the television mode, the computer mode and the combination television/computer mode.

2. U.S. Pat. No. 6,047,121, invented by Vaughn entitled “Method And Apparatus For Controlling A Display Monitor In A PC/TV Convergence System”

The patent to Vaughn describes a computer system comprising a display monitor including an audio function and a computer coupled to the display monitor including a computer controller for controlling the audio function in the monitor. The computer is operable in a computer mode, a television mode, and a combination computer/television mode for displaying computer and television information on the monitor. The system determines whether the monitor includes a controller for controlling its audio function. Based upon this determination, the system controls the audio function with the audio controller in the monitor if the monitor includes such a controller or, alternatively, with the computer controller if the monitor does not have such a controller.

3. U.S. Pat. No. 6,011,592, invented by Vaughn et al. entitled “Computer Convergence Device Controller For Managing Various Display Characteristics”

The patent to Vaughn et al. describes a computer convergence device, operable in a computer mode and, for example, a television mode, includes a computer, a display monitor for displaying images in both the computer mode and the television mode, and multiple video inputs for receiving various types of video signals, each being selectable during operation in television mode. A controller device is coupled to the computer for independently controlling and storing user selected video geometry settings for both the computer mode and the television mode, and further for independently controlling and storing user selected video quality settings for the computer mode, and each of the various video inputs.

4. U.S. Pat. No. 6,100,936, invented by Jordan et al., entitled “Multiple-Screen Video Adapter With Television Tuner”

The patent to Jordan et al. describes video adapter hardware and software permitting the display of computer information and television signals across several display devices. The video adapter hardware includes two graphics user interface accelerators, two television tuners, one or more video decoders, and one or more video multiplexers. Each accelerator is coupled to a memory unit for access to graphics data. One television tuner accepts input from an outside television source, such as a cable television company or a video cassette recorder. In addition, the video multiplexers accept input from other external video sources. Video data is output from the graphics accelerators to multiple screens. Video adapter software displays a tool window allowing the user to select first input for the first display device and a second input for the second display device. The software displays the results of the two inputs on the respective display devices. If the inputs are identical, however, the information may be displayed across both display devices.

5. U.S. Pat. No. 6,069,669, invented by Park et al., entitled “Video Window Control Apparatus And Method Thereof”

The patent to Park et al. describes an improved video window control apparatus and a method thereof which are capable of generating a plurality of video windows on a television or a computer monitor, controlling the size and position thereof, and providing a video window overlap function and a picture-in-picture function. The apparatus includes a video window flow control means for controlling the size based on an input control of a video window and a position and overlap of the video windows based on a video output control and for outputting a video windows input control signal, a video output control signal, and a video selection signal, a plurality of video memory means for receiving a video signal outputted from an external video input and processing means in accordance with the video input control signal and for limitedly outputting the video signals in accordance with a video output control signal, and a video combining means for combining the video signals from the video memory into one video signal in accordance with the video selection signal and for outputting the video signal to an external video output means.

6. U.S. Pat. 6,028,643, invented by Jordan et al., entitled “Multiple-Screen Video Adapter With Television Tuner”

The patent to Jordan et al. describes video adapter hardware and software permitting the display of computer information and television signals across several display devices. The video adapter hardware includes two graphics user interface accelerators, two television tuners, one or more video decoders, and one or more video multiplexers. Each accelerator is coupled to a memory unit for access to graphics data. One television tuner accepts input from an outside television source, such as a cable television company or a video cassette recorder. In addition, the video multiplexers accept input from other external video sources. Video data is output from the graphics accelerators to multiple screens. Video adapter software displays a tool window allowing the user to select first input for the first display device and a second input for the second display device. The software displays the results of the two inputs on the respective display devices. If the inputs are identical, however, the information may be displayed across both display devices.

7. U.S. Pat. No. 5,900,867, invented by Schindler et al., entitled “Self Identifying Remote Control Device Having A Television Receiver For Use In A Computer”

The patent to Schindler et al. describes an entertainment system having a personal computer as the heart of the system with a large screen VGA quality monitor as the display of choice. The system has digital satellite broadcast reception, decompression and display capability with multiple radio frequency remote control devices which transmit self identifying signals and have power adjustment capabilities. These capabilities are used to provide context sensitive groups of keys which may be defined to affect only selected applications running in a windowing environment. In addition, the remote control devices combine television and VCR controls with standard personal computer keyboard controls. A keyboard remote also integrates a touchpad which is food contamination resistant and may also be used for user verification. Included in the system is the ability to recognize verbal communications in video signals and maintain a database of such text which is searchable to help identify desired programming in real time.

8. U.S. Pat. No. 5,977,933, invented by Wicher et al., entitled “Dual Image Computer Display Controller”

The Wicher et al. invention describes a display control system for portable computer drives, from a single frame buffer, both a built-in flat panel (LCD type) display as well as a separate external CRT display or an NTSC/PAL television monitor. Either identical or different images may be displayed simultaneously on the CRT display or television and on the flat panel display. Independent clocking is provided to each display to enable this simultaneous display of different images as well as simultaneously display of identical images. The display control system is suitable for use with a wide variety of CRT displays and flat panel displays by means of internal programmable controls.

9. U.S. Pat. No. 6,046,721, invented by Song et al., entitled “Multi-Functional Monitor”

The Song et al. patent describes a multi-functional monitor which includes a plurality of availability of mature circuits, including a TV signal processing circuit, a signal amplifying circuit, a H/V deflection circuit, a CRT display tube, an AV switching circuit, a video and audio output/input circuit, and a FM radio receiver. The multi-functional monitor further includes the following newly designed circuits to incorporate with the above mature circuits, including a switcher A, a switcher B, a micro controller unit, a TV flyback pulse simulating circuit, and an integrated control circuit. The multi-functional monitor possesses the functions of being used either as a computer color CRT monitor or at the same time as a multi system color television. Apart from these, there are other additional functions of its such as that of Karaoke and AV output/input and FM radio receiver. It does not need for the external speaker and the input of AV signals to operate the computer in multimedia way. It is particularly convenient for the interactive mutual-act data network which is composed of computers, broadcast televisions and telecommunications.

10. U.S. Pat. No. 5,790,201, invented by Antos, entitled “Television And Computer Capability Integration”

The Antos invention describes a television and computer integration system that includes a coupler module electrically coupled to a remote keyboard and integral mouse. Coupler module is also electrically coupled to both a personal computer and to a conventional television. The personal computer has a conventional user interface which includes a keyboard, monitor and mouse. The coupler module enables the combination of the remote keyboard and mouse, and television to serve as a secondary user interface for the personal computer which may be operated in parallel with the primary user interface. A user may thus access and take advantage of substantially all of the capabilities of the personal computer (including computer games and Internet access) from the user's television, in the comfort of the user's living room or television room. The present invention thus advantageously provides efficient and inexpensive integration of television capabilities with personal computing, including Internet access.

It is suggested that the first-above noted patent to Belmont represents the closest prior art to the present invention in theme and general objectives. However, multiple features distinguish the present invention from this prior art device, much to the benefit of users thereof.

Firstly, the Belmont system comprises a television for receiving and displaying images, with a computer coupled to the television for executing and generating images to be displayed on the television set. As such, the Belmont invention primarily lies in the interfacing of the computer and television, with a conversion of the television NTSC interface signals to a scan VGA signal. Stated simply, although the Belmont system comprises a computer program acting as a control device to facilitate interfacing, the television set as an accessory is integral to the system.

In contrast to the above, the present invention provides a computer-television compatibility device, either in the form of an accessory to previously existing systems or a device built into new systems. Specifically, an electronic receiver functions to combine the convenience of the personal computer with the digital transmissions of television, via cable line, traditional antenna, or satellite signal.

To accomplish such, a live cable line, antenna, or satellite network signal is sent to an input box, processed for clarity, then transmitted to an output section of the device which is connected to a computer system. Importantly, unlike in the prior art, a software application functions to display the incoming signal on the previously-existing computer monitor. Therefore, this dispenses with the need for an actual television set. Next, the digital television images may be “dragged” to a corner of the computer screen, and minimized or maximized by the user. Such television images may even be recorded by the user, via CD or DVD means, for subsequent viewing or archival purposes. In total, then, the present invention allows the computer monitor to function as a partial or full television screen, for the traditional purposes of entertainment or information, in a manner that is far more convenient and efficient than the prior art.

### SUMMARY OF THE INVENTION

As noted, the present invention is a computer-television compatibility system. Specifically, the invention is an electronic receiver that combines the convenience of the personal computer with the digital transmissions of a television. The system allows a user to watch television on a standard personal computer monitor for the purposes of entertainment or information.

As such, it is an object of the present invention to provide a system that dispenses with the need for an external television set.

It is also a particular object of the present invention to provide a unique receiving device that processes an incoming broadcast television signal for clarity purposes.

It is an object of the present invention to provide a system that allows the user to view television signals via cable line, antenna, or satellite network upon a computer monitor.

It is another object of the present invention to provide the compatibility device described above as an accessory to previously existing computer systems.

It is also an object of the present invention to provide the compatibility device described above as a component built into new computer systems.

It is an object of the present invention to provide pointing, clicking, minimizing, maximizing, and dragging functions to the computer user, for the purposes of controlling and manipulating the display of the incoming broadcast television signal upon the computer monitor.

Finally, it is the intention of the present invention to provide a system that allows the user to record the incoming broadcast television via convenient CD or DVD means.

In total, the novel features considered characteristic for the invention are set forth in the claims. The invention itself both as to its construction and method of operation, will be best understood from the following description of the embodiments when read and understood in connection with the drawings provided.

### BRIEF DESCRIPTION OF PREFERRED EMBODIMENTS

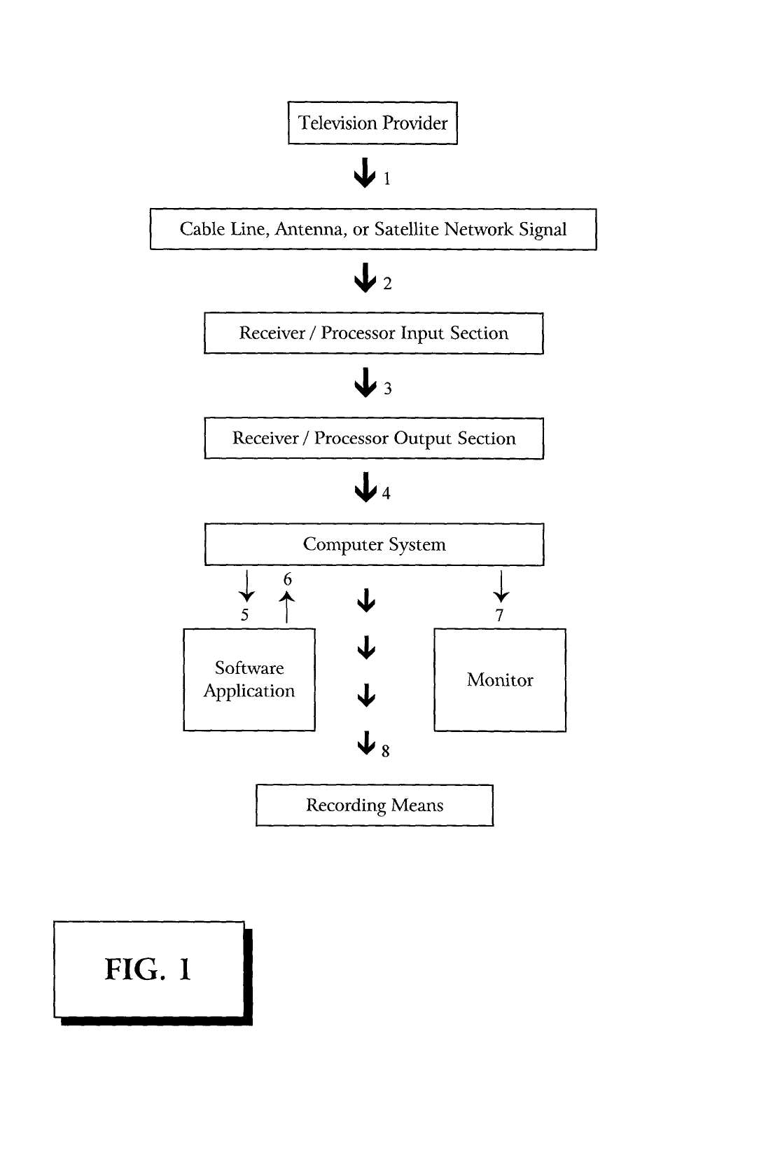

FIG. 1 is a flowchart of a first embodiment of the present invention, wherein the device functions as an accessory to previously existing computer systems.

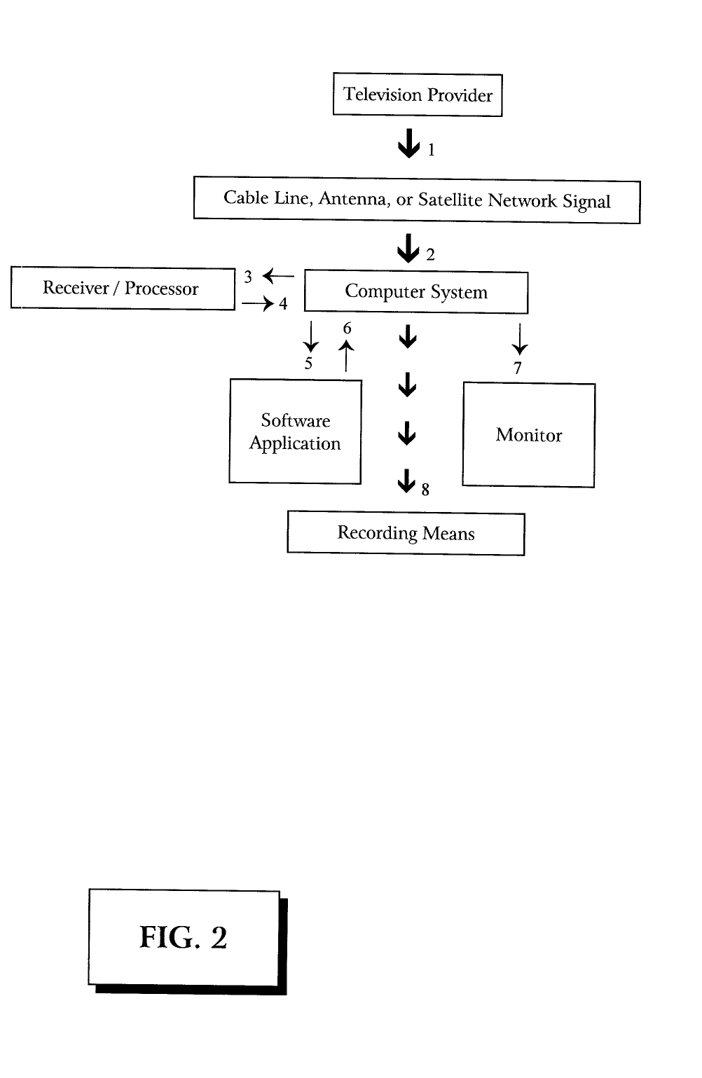

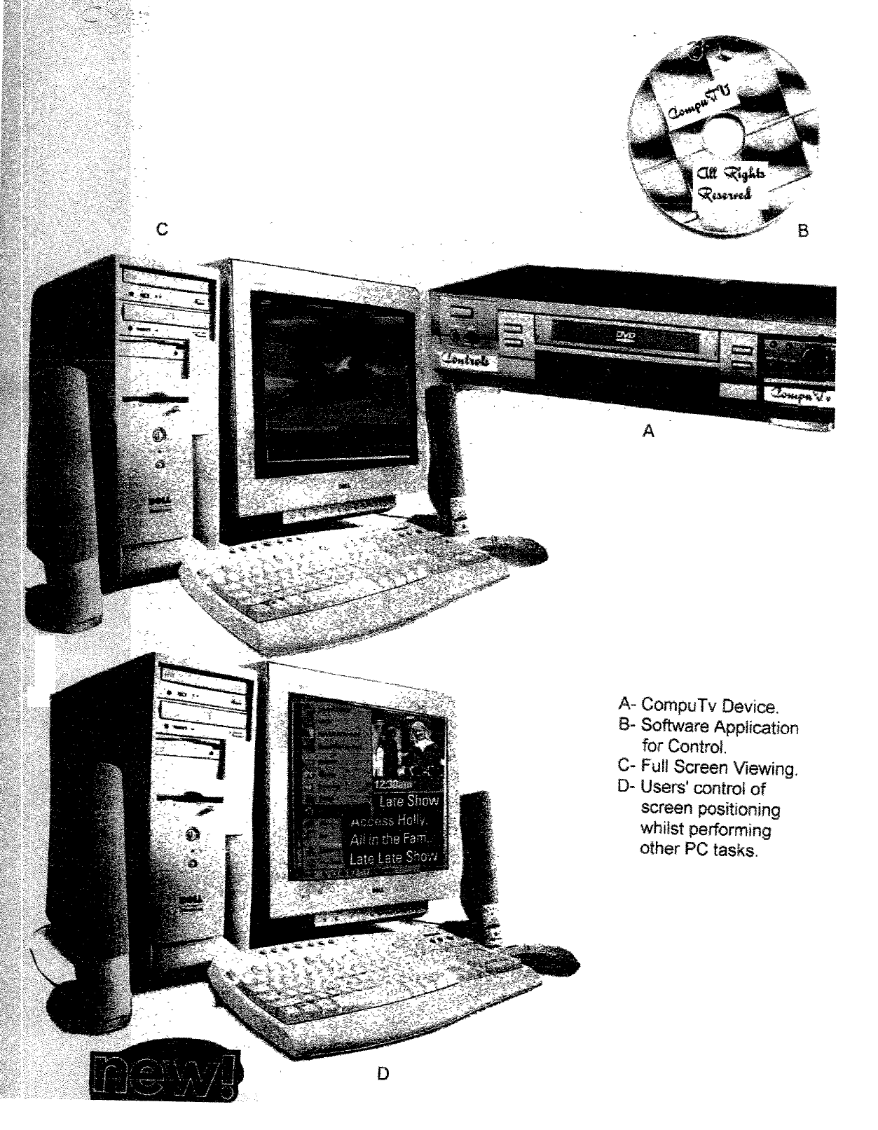

FIG. 2 is a flowchart of a second embodiment of the present invention, wherein the device is manufactured as an integral component of new computer systems.

### DETAILED DESCRIPTION OF THE PREFERRED EMBODIMENT

The first description relates to FIG. 1, which is a flowchart of a first embodiment of the present invention, wherein the device functions as an accessory to previously existing computer systems. Specifically, a computer-television compatibility system comprises an external electronic receiver, which comprises an input section, processor, and output section.

Generally, the input section functions to receive a broadcast television signal. In all instances described herein, the broadcast television signal may be via antenna means, cable line means, or satellite signal means. Such will allow users of any of the above common television systems to utilize the system of the present invention, irrespective of the type of television package to which the user subscribes.

Next, the present system's processor functions to process the incoming broadcast television signal for clarity purposes. Such ensures that a quality image will be viewed by the user at all relevant times. The present system's output section of the receiver then functions to transmit the incoming broadcast television signal to a computer system, such as a traditional PC.

As such, the computer system comprises a central processing unit, at least one input device, a monitor, and a recording means. Importantly, a software application functions to display the broadcast television signal on the computer monitor.

The software application further functions to allow a user to engage at least one input device to manipulate a display of the broadcast television signal. Specifically, in combination with a mouse, writing tablet, or other input device, the software application allows the user to manipulate the display of the broadcast television signal by traditional pointing to the image, clicking upon the image display, and dragging the image display section to desired locations upon the computer monitor screen. The software application and input device further function to allow the user to minimize and maximize the display of the broadcast television signal.

Due to the above, the user of the present invention is able to view live television upon the existing computer monitor while engaging in work activities or entertainment, at home or in the office. Due to the ability to control both the size and location of the incoming television image display section, the user can customize the same to a particular desired appearance. Thus, the television image will not interfere with the user's computing activity, but will instead enhance the experience of using the computer to previously unattained levels.

Accordingly, the present invention can be enjoyed by a great variety of users who desire or need television access throughout their work day or computing activities. Such uses may include entertainment, such as a sporting event, concert, movie, or television show, or may include news items, particularly regarding television reports of ongoing noteworthy events or unfolding activities of great importance.

Finally, it should be noted that the user may utilize the existing components of the computer system to record the incoming television broadcast signal for a variety of archival purposes. As such, the recording means may be the simple and convenient CD and DVD units.

The next description relates to FIG. 2, which is a flowchart of a second embodiment of the present invention, wherein the device is manufactured as an integral component of new computer systems.

In the alternate mode, a computer-television compatibility system comprises a computer system, which comprises a receiver unit built directly into the computer form the manufacturer, as well as a central processing unit, at least one input device, a monitor, and a recording means.

The receiver comprises an input section, processor, and output section. As was the case regarding the first embodiment, the input section functions to receive a broadcast television signal, the processor functions to process the broadcast television signal for clarity purposes, and the output section functions to transfer the broadcast television signal to the central processing unit.

Like in the case noted above, a software application functions to display the broadcast television signal on the monitor. The software application further functions to allow a user to engage at least one input device to manipulate a display of the broadcast television signal. Again the broadcast television signal is selected form the group consisting of antenna means, cable line, and satellite signal.

The software application and input device function to allow the user to manipulate the display of the broadcast television signal, including pointing, clicking, and dragging. The software application and input device also function to allow the user to minimize and maximize the display of the broadcast television signal. Once again, the recording means is selected from the group consisting of CD and DVD means.

This second embodiment allows a user to simply purchase a new computer system that is already equipped with the computer-to-television conversion components. Thus, the user who desires a new system need not concern his or herself with the separate receiver component as outlined above. Instead, the user is able to enjoy all of the benefits of the system as noted herein, in a simple manner that further serves to conserve space at the user's workstation.

With regards to all FIGURES, while the invention has been illustrated and described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

Without further analysis, the foregoing will so fully reveal the gist of the present invention that others can readily adapt it for various applications without omitting features that, from the standpoint of prior art, constitute essential characteristics of the generic or specific aspects of this invention. What is claimed as new and desired to be protected by Letters Patent is set forth in the appended claims.

What is claimed is:

1. A computer-television compatibility system comprising:
A. an external electronic receiver which comprises an input section, processor, and output section, the input section functioning to receive a broadcast television signal, the processor functioning to process the broadcast television signal for clarity purposes, the output section functioning to transmit the broadcast television signal to a computer system;
B. the computer system comprising a central processing unit, at least one input device, a monitor, and a recording means;
C. a software application functions to display the broadcast television signal on the monitor, and further functions to allow a user to engage at least one input device to manipulate a display of the broadcast television signal.

2. The computer-television compatibility system as described in claim 1, wherein the broadcast television signal is selected form the group consisting of antenna means, cable line, and satellite signal.

3. The computer-television compatibility system as described in claim 1, wherein the software application and input device function to allow the user to manipulate the display of the broadcast television signal in a manner selected from the group consisting of pointing, clicking, and dragging.

4. The computer-television compatibility system as described in claim 1, wherein the software application and input device function to allow the user to minimize and maximize the display of the broadcast television signal.

5. The computer-television compatibility system as described in claim 1, wherein the recording means is selected from the group consisting of CD and DVD means.

6. A computer-television compatibility system comprising:
A. a computer system comprising a receiver, central processing unit, at least one input device, a monitor, and a recording means;
B. the receiver comprises an input section, processor, and output section, the input section functioning to receive a broadcast television signal, the processor functioning to process the broadcast television signal for clarity purposes, the output section functioning to transfer the broadcast television signal to the central processing unit;
C. a software application functions to display the broadcast television signal on the monitor, and further functions to allow a user to engage at least one input device to manipulate a display of the broadcast television signal.

7. The computer-television compatibility system as described in claim 6, wherein the broadcast television signal is selected form the group consisting of antenna means, cable line, and satellite signal.

8. The computer-television compatibility system as described in claim 6, wherein the software application and input device function to allow the user to manipulate the display of the broadcast television signal in a manner selected from the group consisting of pointing, clicking, and dragging.

9. The computer-television compatibility system as described in claim 6, wherein the software application and input device function to allow the user to minimize and maximize the display of the broadcast television signal.

10. The computer-television compatibility system as described in claim 6, wherein the recording means is selected from the group consisting of CD and DVD means.
